(19) United States
(12) Patent Application Publication
(10) Pub. No.: US 2012/0194443 A1
(43) Pub. Date: Aug. 2, 2012

(54) DETACHABLE KEY AND KEYBOARD THEREOF

(75) Inventors: Shao-Yu Hwang, Taipei City (TW); Stephen Tsai, New Taipei City (TW); Mei-Ching Tsai, Taipei City (TW); Li-Li Lai, Taipei City (TW)

(73) Assignee: HANNSPREE, INC., New Taipei City (TW)

(21) Appl. No.: 13/092,295

(22) Filed: Apr. 22, 2011

(30) Foreign Application Priority Data
Feb. 1, 2011 (TW) 100103943

(51) Int. Cl. G06F 3/041; G09G 5/00

(52) U.S. Cl. 345/173; 345/156

(57) ABSTRACT

A detachable key has a character generator, a control signal generator, a wireless module, and a connection part. The control signal generator generates a control signal when a user presses or touches the control signal generator. The character generator generates a character signal according to the control signal. The wireless module receives the character signal and transmits the character signal to a computing device via a wireless transmission manner. The connection part is used to connect the detachable key with the other detachable keys. The user may freely connect detachable keys to form the demanded keyboard according to the user's requirements, and thus the detachable key is convenient to the user.

### BACKGROUND

1. Technical Field

The present invention relates to a keyboard of a computing device, in particular, to a detachable key on the keyboard.

2. Description of Related Art

The keys of the conventional keyboard are situated on the fixed or permanent locations, and the difference between the keyboards made by manufactures is that the locations of the function keys are all slightly different. Now, some manufactures provide the keyboards with the removable keys to the users for cleaning the keys or replacing the old keys. In addition, some manufactures further provide the keyboards with keys which can be specified or defined by the users.

However, the keys of the above keyboard are still on the fixed or permanent locations, and the keys are usually arranged in the ordinary rectangular type. Thus, the fixed or permanent locations of the keys limit the space for the user using the keyboard. If there are more than two users using the same keyboard and display simultaneously, the crowded space will be very inconvenient.

When multiple users play computer game on the same computer device, it is often inconvenient to them for using the same keyboard because of the fixed or permanent locations of keys of the keyboard. Some users may further buy the game controllers or the virtual game controllers, but both of them will cause extra cost.

### SUMMARY

An exemplary embodiment of the present invention provides a detachable key comprising a character generator, a control signal generator, a wireless module, and a connection part. The control signal generator generates a control signal when a user presses or touches the control signal generator. The character generator generates a character signal according to the control signal. The wireless module receives the character signal and transmits the character signal to a computing device via wireless transmission. The connection part is used to connect the detachable key with the other detachable keys.

According to an exemplary embodiment of the present invention, the detachable key further comprises a magnetic base, and the connection part is the magnetic base of the detachable key, wherein the wireless module, the character generator, and the control signal generator are located on the magnetic base.

According to an exemplary embodiment of the present invention, the detachable key further comprises a power supply, and the connection part comprises a locking slot and a locking part of the base of the detachable key, wherein the detachable key comprising the power supply may further provide power to the other detachable keys connected thereto.

According to an exemplary embodiment of the present invention, the detachable key comprises a key structure and a protrude point, when user presses the key structure, the protrude point is brought to touch the control signal generator.

According to an exemplary embodiment of the present invention, the control signal generator may be a liquid crystal display (LCD) touch panel.

An exemplary embodiment of the present invention provides a keyboard formed by a connection of a plurality of detachable keys, wherein each detachable key comprises a character generator, a control signal generator, a wireless module, and a connection part. The control signal generator generates a control signal when a user presses or touches the control signal generator. The character generator generates a character signal according to the control signal. The wireless module receives the character signal and transmits the character signal to a computing device via a wireless transmission manner. The connection part is used to connect the detachable key with the other detachable keys. In addition, at least one detachable key further comprises a power supply to provide power to the other detachable keys connected thereto.

To sum up, the detachable keys provided by exemplary embodiments of the present invention may be freely connected to form the demanded keyboard according to the user's requirements, and thus the detachable key is convenient to the user.

In order to further understand the techniques, means and effects the present invention, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic diagram showing that a user uses a detachable key to control a computing device according to an exemplary example of the present invention.

FIG. 2A is a sectional view of a detachable key according to an exemplary example of the present invention.

FIG. 2B is a sectional view of a detachable key according to another one exemplary example of the present invention.

FIG. 2C is a sectional view of a detachable key according to another one exemplary example of the present invention.

FIG. 3 is a block diagram of a detachable key according to an exemplary example of the present invention.

FIG. 4 is a schematic diagram showing that multiple detachable keys are connected to form a keyboard simulating the black keys and white keys of a piano.

FIG. 5A through FIG. 5C are respectively a top, a bottom, and a side view of a keyboard simulating the flute, wherein multiple detachable keys are connected to form this keyboard.

FIG. 6 is a schematic diagram showing that multiple detachable keys are connected to form a keyboard simulating two users' game controllers.

FIG. 7 is a schematic diagram showing that multiple detachable keys are attracted to a magnetism attracting object to form a keyboard simulating the user's game controller.

### DESCRIPTION OF THE EXEMPLARY EMBODIMENTS

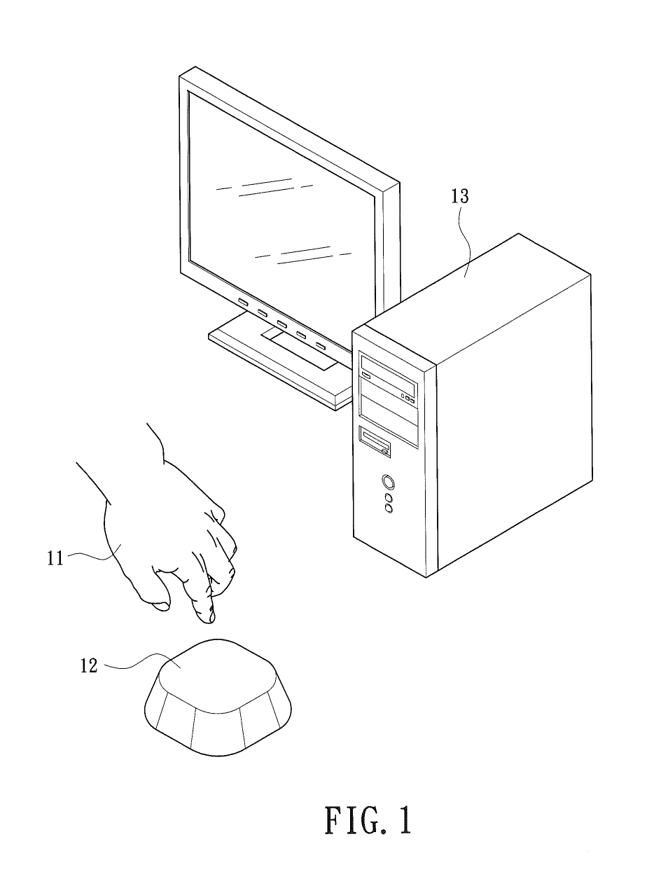

FIG. 1 is a schematic diagram showing a user 11 uses a detachable key 12 to control a computing device 13 according to an exemplary example of the present invention. In FIG. 1, the user 11 may use his/her finger to press or touch the detachable key 12 provided by this exemplary embodiment of the present invention, so as to generate the character signal corresponding to the detachable key 12. The detachable key 12 has a wireless module transmitting the character signal to the computing device 13.

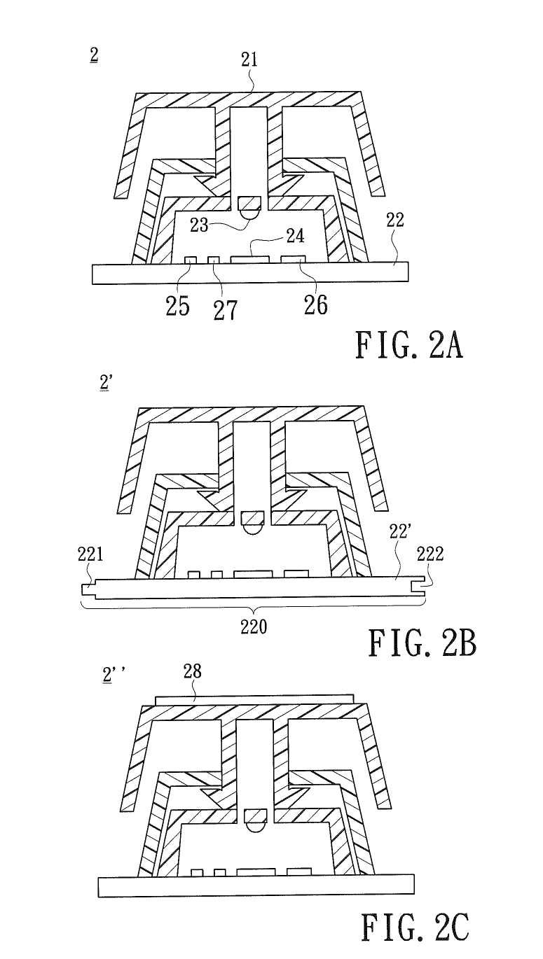

The detachable key 12 in FIG. 1 may be connected to the other detachable keys to form different types of layout keyboards. A base 22 of the detachable key 12 is a magnetic base, such that the detachable keys 12 can be connected to each other. However, the detachable key 12 is not limited to be the detachable key 12 having the magnetic base, and it can be the detachable key 12 with a connection part 220 (as shown in FIG. 2B) to connected the other detachable keys 12. For example, the detachable key 12 may be designed to have a hook and a corresponding hole, or may be designed to have VELCRO material on its surface. Furthermore, the detachable key 12 may be designed to have the locking slot 222 and the locking part 221 on the base 22 (as shown in FIG. 2B).

Referring to FIG. 2A, FIG. 2A is a sectional view of a detachable key according to an exemplary example of the present invention. The detachable key 2 comprises a key structure 21, a base 22, a protrude point 23, and a control signal generator 24. The base 22 is a magnetic base, and has a wireless module 25, a power supply 26, and a character generator 27. In addition, the control signal generator 24 is located on the base 22. The control signal generator 24 is electrically connected to the power supply 26 and the character generator 27, the character generator 27 is electrically connected to the wireless module 25 and the power supply 26, and the wireless module 25 is electrically connected to the power supply 26.

The key structure 21 is an elastic pressing structure. When the downward force is applied on the key structure 21, the key structure 21 moves downward, and the protrude point 23 is therefore brought to move downward to touch the control signal generator 24. When downward force is not applied on the key structure 21, the key structure 21 restores to its original position due to the elasticity thereof, and the protrude point 23 is therefore brought to restore to the original position thereof, such that the protrude point 23 separates from the control signal generator 24 not touching the control signal generator 24.

In FIG. 2A, the control signal generator 24 is a touching switch, and the touching switch is a soft pad switch with elasticity. While the control signal generator 24 is touched by the protrude point 23, the state of the control signal generator 24 changes from a first state to a second state. When the control signal generator 24 is not touched by the protrude point 23, the state of the control signal generator 24 returns to the first state from the second state. It is noted that, the first and the second states are respectively a conducting and an open states, or the first and the second states are respectively an open and a conducting states.

When the state control signal generator 24 is in the second state (i.e. the user touches or presses the detachable key 2), the control signal generator 24 generates the control signal to character generator 27. The character generator 27 generates a character signal to the wireless module 25 while it receives the control signal. The wireless module 25 transmits the character signal to the computing device 13 via the wireless transmission manner (as shown in FIG. 1).

Additionally, the character signal generated by the character generator 27 can be defined by the computing device 13. The computing device 13 may transmit the character definition signal to the wireless module 25, and the wireless module 25 then transmits the character definition signal to the character signal generator 27, such that the character signal generated by the character generator 27 is defined correspondingly. In another one exemplary embodiment, the base 22 may have a Dual In-line Package (DIP) switch or the jumper, such that the user can use the DIP switch or the jump to define the character signal generated by the character generator 27.

By the way, the key structure 21 may have a writing plate on its top surface, such that the user can write the character corresponding to the defined character signal on the writing plate. In the other exemplary embodiment 21, the key structure 21 may the display panel 28 (as shown in FIG. 2C, the detachable key 2″ has the display panel 28). The display panel 28 may be LCD display panel or electrophoresis display panel (e-paper panel) for displaying the character corresponding to the defined character signal.

Referring to FIG. 2B, FIG. 2B is a sectional view of a detachable key according to another one exemplary example of the present invention. The difference between the detachable key 2′ in FIG. 2B and the detachable key 2 in FIG. 2A is that a base 22′ of the detachable key 2′ is not a magnetic base, but the detachable key 2′ has the base 22′ comprising a locking part 221 and a locking slot 222. The locking part 221 and the locking slot 222 of the detachable key 2′ form a connection part 220, such that the detachable key 2′ can be connected to the other detachable keys via this connection part 220. In addition, the locking part 221 and the locking slot 222 may further comprises a metal conductor, such that the detachable key 2′ can provide power to the connected detachable keys lacking off the power supply via the locking part 221 and the locking slot 222.

It is noted that FIG. 2A and FIG. 2B show the sectional views of the detachable key, and FIG. 2A and FIG. 2B are merely corresponding to some exemplary embodiments of the present invention, and the present invention is not limited thereto. The detachable key 2 may be implemented by a touch display apparatus of the small dimension (i.e. the small dimension is similar to the dimension of a key in the keyboard). The touch display panel of the touch display apparatus can be served as the control signal generator, and the touch display apparatus has the character signal generator, the power supply, and the wireless module located therein. Furthermore, the base 22 of the detachable key may be the magnetic base or the base 22′ having the locking part and the locking slot, and the locking part and the locking slot are served as the conducting pins, such that the power supply of the detachable key can provide power to the connected detachable keys without the power supply.

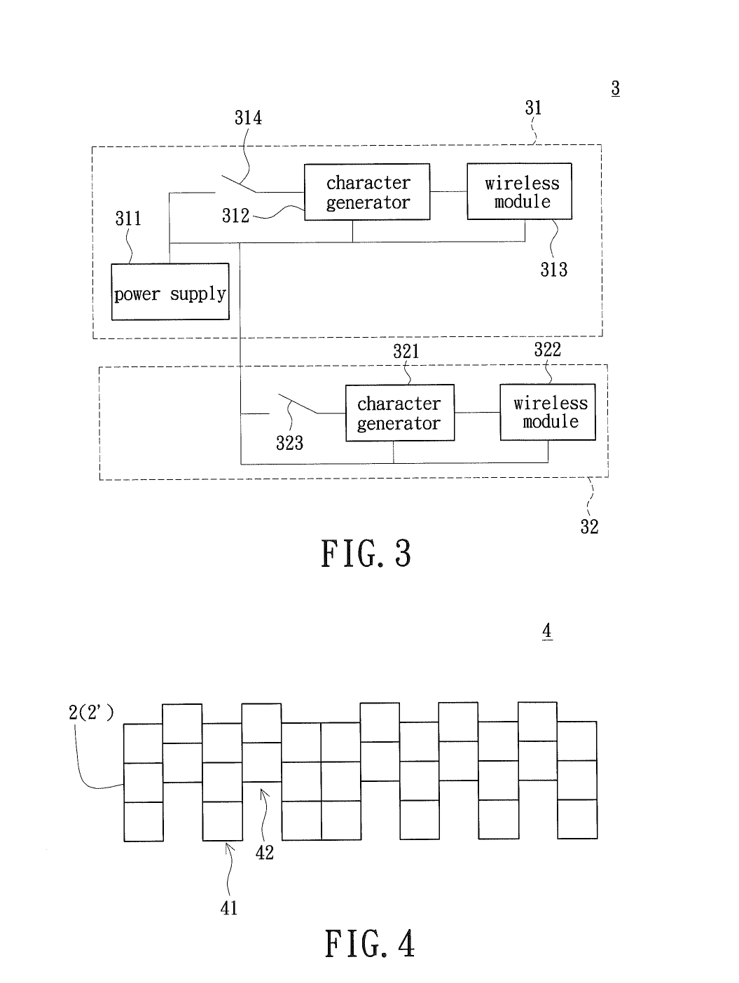

Referring to FIG. 3, FIG. 3 is a block diagram of a detachable key 31 according to an exemplary example of the present invention. The detachable key 31 may have a power supply power supply actively providing power to the other connected detachable keys, wherein the other connected detachable keys 32 without the power supply. In FIG. 3, the two detachable keys 31 and 32 can be connected to form a simple keyboard 3 having two keys. The detachable key 31 has a power supply 311, a control signal generator 314, a character generator 312 and a wireless module 313. The detachable key 32 without the power supply 311, but still has a character generator 321, a control signal generator 323 and a wireless module 322. In this exemplary embodiment, the control signal generators 314 and 323 are implemented by the touching switch.

The power supply 311 provides power to the character generator 312 and the wireless module 313, and further can provide the power to the character generator 312 and the wireless module 313 in the detachable key 32 via the metal conductors of the locking part 221 and the locking slot 222 (as shown in FIG. 2B). When the control signal generator 314 is pressed or touched, the state of the control signal generator 314 changes to the conducting state from the open state. Meanwhile, the control end of the character generator 312 receives the voltage signal, and correspondingly generates the character signal to the wireless module 313. In the similar manner, when the control signal generator 323 is pressed or touched, the character generator 321 generates the character signal to the wireless module 322. The character signals respectively generated by the character generators 312 and 321 can be defined by the user as mentioned above.

Additionally, it is noted that when the character generators 312 and 321 receive the high voltage signal (i.e. the control signal with the high level) in this exemplary embodiment, the character signals are generated correspondingly. In an alternative exemplary embodiment, the character generators 312 and 321 are designed to generate the character signals when receiving the low voltage signal (i.e. the control signal with the low level). However, in this alternative exemplary embodiment the control signal generators 314 and 323 (implemented by the touching switches) are designed to be at conducting state usually, and to change to the open state from the conducting state when the control signal generators 314 and 323 are touched or pressed.

FIG. 3 illustrates an exemplary embodiment of the detachable key implemented by the mechanical key. However the detachable key may be also implemented by the touch display apparatus of the small dimension. Meanwhile the control signal generators 314 and 323 can be respectively replaced by the two touch display panels, and the two touch display panels need the power supply to provide power thereto. When the touch display panel is touched by the user, the touch display panel generates a control signal, and the control signal indicates the character generator to generate the character signal.

According to the above description, the exemplary embodiment of the present invention provides a detachable key having a wireless module, a character generator, and a control signal generator. When the control signal generator (implemented by the touching switch or the touch display panel) is touched or pressed, the control signal generator generates the control signal to control the character signal to generate the character signal, and the character signal is then transmitted to the wireless module. The wireless module is used to transmit the character signal to the computing device via a wireless transmission manner. The detachable key further comprises the connection part, and the connection part is used to connect the other detachable keys.

The exemplary embodiments of the keyboards formed by the connection of the detachable keys are illustrated as follows. These detachable keys are described above, the implementation of the connection part in the detachable key is limited thereto, and whether the detachable key has the power supply of is also not limited thereto.

Referring to FIG. 4, FIG. 4 is a schematic diagram showing that multiple detachable keys are connected to form a keyboard 4 simulating black keys 42 and white keys 41 of a piano. The keyboard 4 in FIG. 4 comprises a plurality of detachable keys 2 in FIG. 2A or detachable keys 2′ in FIG. 2B, and these detachable keys 2 or 2′ are connected to form the keyboard 4 simulating the black keys 42 and the white keys 41 of the piano, wherein the detachable keys at the same column (i.e. the detachable keys of the same black or white key) are defined to generate the same character signal.

In FIG. 4, the black key 42 may be form by the connection of the two detachable keys, and the white key 41 may be formed by the connection of the three detachable keys. The black key 42 and the white key 41 are interlaced, therefore forming the keyboard similar to the keys of a piano. The user may use this keyboard 4 to play the music game or to operate the music edition software.

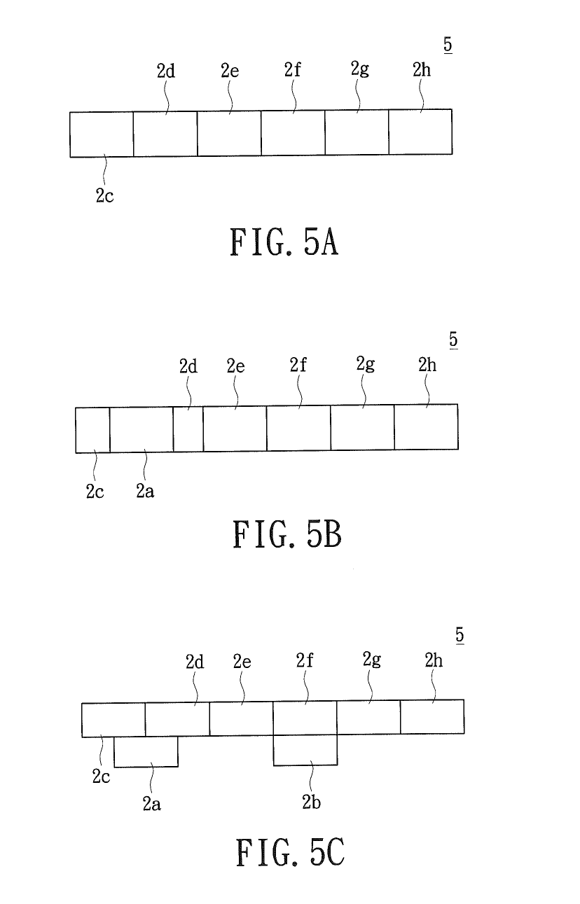

Referring to FIG. 5A through FIG. 5C, FIG. 5A through FIG. 5C are respectively a top, a bottom, and a side view diagrams of a keyboard 5 simulating a flute, wherein multiple detachable keys are connected to form this keyboard 5. The keyboard 5 is a three-dimensional keyboard rather than a planar keyboard, and is formed by the connection of the detachable keys 2a through 2h. The character signals generated by the detachable keys 2a through 2h are not identical to each other, and character signals generated by the detachable keys 2a through 2h can be defined by the user as mentioned above.

In FIG. 5A through FIG. 5C, it is known that the detachable keys are connected to form the keyboard 5 simulating a flute. The user may use his/her two hands to operate the keyboard 5, and therefore the user may feel him/her playing the flute. When user plays the music game or operate the music edition software, the user may enjoy the scheme of playing flute if he/she uses the keyboard 5 provided by FIG. 5A through FIG. 5C.

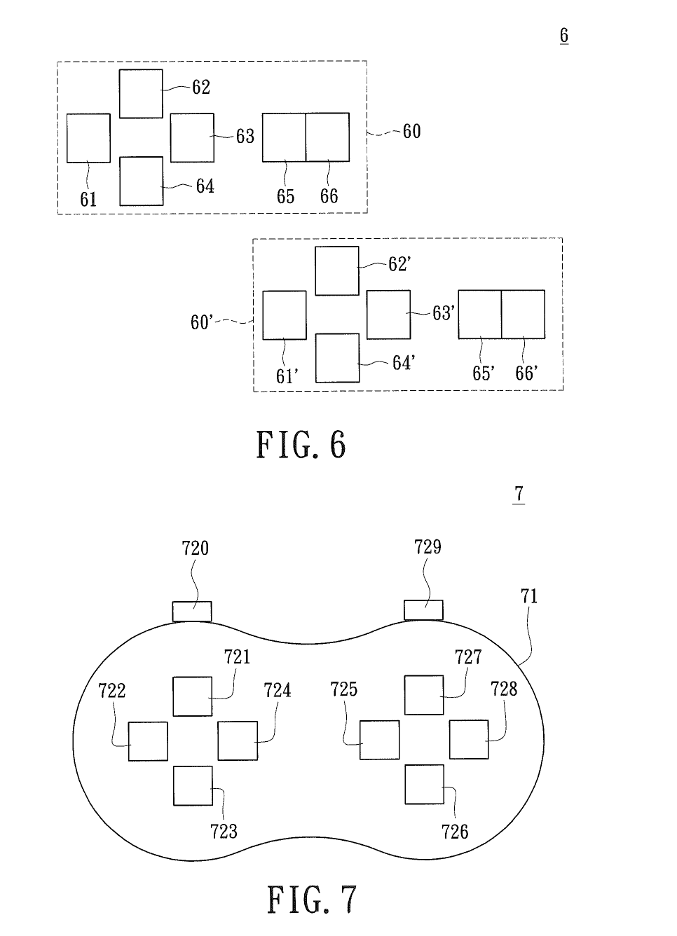

Referring to FIG. 6, FIG. 6 is a schematic diagram showing that multiple detachable keys are connected to form a keyboard 6 simulating two game controllers. In FIG. 6, the keyboard 6 served as the two game controllers comprises a first sub keyboard 60 and a second sub keyboard 60′, wherein the first and second sub keyboards 60 and 60′ are respectively used by the first and second players. The first sub keyboard 60 comprises multiple detachable keys 61 through 66, and the second sub keyboard 60′ comprises multiple detachable keys 61′ through 66′.

The detachable keys 61 through 66 can be respectively defined to be the left, up, right, down, first function, and second function keys of the first player when playing the game. The detachable keys 61′ through 66′ can be respectively defined to be the left, up, right, down, first function, and second function keys of the second player when playing the game. It is known that the crowded and inconvenient problems can be prevented by using the keyboard 6 when the two players simultaneously play the game.

Referring to FIG. 7, FIG. 7 is a schematic diagram showing that multiple detachable keys are attracted to a magnetism attracting object to form a keyboard 7 simulating a game controller. In FIG. 7, the detachable keys 720 through 729 are attracted to a metal base 71 having the magnetism attracting characteristic, such that the keyboard 7 is formed. The user may use the other magnetism attracting material or object to replace the metal base 71. In FIG. 7, the positions and distances between each two detachable keys 720 through 729 may be determined by the user's requirements, such as the user's age, sex, finger size, finger thickness, and so on.

In summary, the user may freely arrange or connect the detachable keys provided by the exemplary embodiment of the present invention to form the demanded keyboard according to the user's requirements, and thus the above detachable key is convenient to the user. In addition, the keyboard formed by these detachable keys may be simultaneously used by at least two users when they simultaneously play the game, and thus the inconvenient and crowded problems may be prevented.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. A detachable key, comprising:
a control signal generator, used to generate a control signal when a user touches or presses the control signal generator;
a character generator, used to generate a character signal according to the control signal;
a wireless module, used to receive the character signal, and to transmit the character signal to a computing device via a wireless transmission manner; and
a connection part, used to connect the other detachable keys.

2. The detachable key according to claim 1, further comprising a magnetic base, and the connection part is the magnetic base of the detachable key, wherein the wireless module, the character generator, and the control signal generator are located on the magnetic base.

3. The detachable key according to claim 1, further comprising a key structure and a protrude point, wherein the control signal generator is a touching switch, when the key structure is pressed by the user, protrude point is brought to touch the touching switch.

4. The detachable key according to claim 1, further comprising a power supply providing power to the detachable key and to the other connected detachable keys.

5. The detachable key according to claim 4, further comprising a base, the base has a locking part and a locking slot thereon, the locking part and the locking slot are served as the connection part, the locking part and the locking slot are further served as a conducting path for the power supply to provide the power to the other connected detachable keys.

6. The detachable key according to claim 1, wherein the control signal generator is a LCD touch panel.

7. The detachable key according to claim 3, wherein the detachable key further comprises a display panel thereon displaying a character corresponding to the character signal.

8. The detachable key according to claim 1, wherein the character signal generated by the character generator is defined according to a character definition signal, and the character definition signal is transmitted to the character generator from the computing device via the wireless transmission manner.

9. The detachable key according to claim 1, further comprising a Dual In-line Package (DIP) switch or a jumper, and the DIP switch and the jumper is used by the user to define the character signal generated by the character generator.

10. A keyboard, formed by a connection of a plurality of detachable keys, wherein each detachable key comprises:
a control signal generator, used to generate a control signal when a user touches or presses the control signal generator;
a character generator, used to generate a character signal according to the control signal;
a wireless module, used to receive the character signal, and to transmit the character signal to a computing device via a wireless transmission manner; and
a connection part, used to connect the detachable key with the other detachable keys;
wherein at least one detachable key further comprises a power supply to provide power to the other detachable keys connected thereto.

11. The keyboard according to claim 10, wherein the detachable key further comprises a magnetic base, and the connection part is the magnetic base of the detachable key, wherein the wireless module, the character generator, and the control signal generator are located on the magnetic base.

12. The keyboard according to claim 10, wherein the detachable key further comprises a key structure and a protrude point, wherein the control signal generator is a touching switch, when the key structure is pressed by the user, the protrude point is brought to touch the touching switch.

13. The keyboard according to claim 10, wherein the detachable key further comprises a base, the base has a locking part and a locking slot thereon, the locking part and the locking slot are served as the connection part, the locking part and the locking slot are further served as a conducting path for the power supply to provide the power to the other connected detachable keys.

14. The keyboard according to claim 10, wherein the control signal generator is a LCD touch panel.

15. The keyboard according to claim 12, wherein the detachable key further comprises a display panel thereon displaying a character corresponding to the character signal.

16. The keyboard according to claim 10, wherein the character signal generated by the character generator is defined according to a character definition signal, and the character definition signal is transmitted to the character generator from the computing device via the wireless transmission manner.

17. The keyboard according to claim 10, wherein the detachable key further comprises a Dual In-line Package (DIP) switch or a jumper, and the DIP switch and the jumper is used by the user to define the character signal generated by the character generator.
